(19) United States
(12) Patent Application Publication
(10) Pub. No.: US 2026/0357016 A1
(43) Pub. Date: Nov. 12, 2026

(54) USE OF ADDITIVES FOR IMPROVING THE PROCESSING OF POLYETHYLENES

(71) Applicant: Milliken Europe BV, Gent (BE)

(72) Inventors: Daniel Mueller, Kaisten (CH); Wiebke Wunderlich-Wippert, Kaisten (CH)

(73) Assignee: Milliken Europe BV, Gent (BE)

(21) Appl. No.: 19/103,583

(22) PCT Filed: Jul. 27, 2023
(86) PCT No.: PCT/EP2023/070833

§ 371 Date: Feb. 13, 2025

(30) Foreign Application Priority Data
Aug. 19, 2022 (EP) 22191286.8

(51) Int. Cl. C08J 3/20; C08J 5/18; C08K 5/1575; C08K 5/20

(52) U.S. Cl. CPC C08J 3/203; C08J 5/18; C08K 5/1575; C08K 5/20; C08J 2323/06

(57) ABSTRACT

A method increases the melt strength and/or melt elasticity and/or the drawability of a polyethylene by adding an additive to the polyethylene. The additive is selected from at least one compound selected from the group consisting of trisamides.

### FIELD OF THE INVENTION

The present invention is directed to the processing of polyethylenes. Specifically, the invention concerns the use of certain additives for improving the melt strength and/or the melt elasticity and/or the drawability of a polyethylene. The inventors have particularly found that one or more of these properties are improved in regard to extrusion techniques, for instance film and fibre preparation, especially blown polyethylene film production. Improvements have been found particularly for mono- and biaxial orientated polyethylene films (BOPE).

### BACKGROUND OF THE INVENTION

Polyethylene can be used in a wide variety of applications. Typically, this can include a number of different articles such as films, extrudates and pipes and many more. Different types of polyethylenes can be produced by a number of processes including low density polyethylene (LDPE), linear low-density polyethylene (LLDPE), high density polyethylene (HDPE).

Polyethylene may for instance be processed by blown moulding, blown film or by the extrusion techniques. During such processing techniques, especially for blown moulding, blown film and extrusion, properties such as melt strength and melt elasticity are often important. Properties such as drawability can also be important during the processing of polyethylene, especially when producing fibres, typically as spun melt or continuous filament, or when producing blown films, typically involving extrusion of the polyethylene through a blown film extruder machine.

US 2011/0171407 A1 discloses a method for increasing the melt strength of a polyethylene resin by reacting the polyethylene resin with an alkoxy amine derivative of the formula: (R1)(R2)N—O—R3 where R1 and R2 are each independently of one another hydrogen, C₄-C₄₂ alkyl or C₄-C₄₂ aryl or substituted hydrocarbon groups comprising O and/or N, and where R1 and R2 may form a ring structure together; and where R3 is hydrogen, a hydrocarbon or a substituted hydrocarbon group comprising O and/or N. This disclosure recognised that melt strength is a practical measurement that can predict material performance when submitted at elongational deformations.

U.S. Pat. No. 10,865,298 B2 describes a composition that includes polyethylene, a multifunctional co-agent having a functionality of 3 or greater, where the multifunctional co-agent is from 100 to 2000 ppm based upon the polyethylene, and a free radical generator, where the fee radical generator is from 5 to 100 ppm based upon the polyethylene. This reference describes that in addition to an improved gel count, high melt strengths may be desirable for polyethylene.

U.S. Pat. No. 10,844,210 B2 teaches a method for increasing the melt strength and/or low shear viscosity of a polyethylene resin. The method comprises: a) providing a first polyethylene resin having a density ranging from 0.900 g/cm³ to 0.970 g/cm³, a melt index ranging from 0.01 g/10 min to 30 g/10 min, and at least 0.20 vinyl groups per 1000 total carbons; b) providing a masterbatch composition comprising a free radical generator and a second polyethylene resin. The free radical generator has a half-life at 220 °C, of less than 200 seconds, and a decomposition energy higher than-250 kJ/mol. The second polyethylene has a density ranging from 0.900 g/cm³ to 0.970 g/cm³, melt index ranging from 0.01 g/10 min to 100 g/10 min. The first polyethylene resin is reacted with the masterbatch composition to form a modified polyethylene resin.

WO 2014/043184 A1 relates to a film structure comprising an outer layer, a core and an inner layer (or sealant layer). The outer layer comprises a polyolefinic material having a Vicat softening temperature of 85 °C or greater, most preferably 90 °C or greater, and a total crystallinity in the range of 25 to 45%. The core is a linear low-density polyethylene having a density of 0.925 g/cm³ or less, and a melt index of 4.0 g/10 min or less. The inner layer (or sealant layer) comprises linear low-density polyethylene having a density of from 0.865 to 0.926 g/cm³ and a melt index of less than 4.0/10 minutes. The films are said to be further characterised by having the total amount of polyethylene having a density of 0.930 g/cm³ or greater which makes up the film being of less than 25% by weight of the entire film. The description reveals that the core may comprise a single layer or, more preferably, multiple layers, with additional layers adding functionality such as barrier properties, melt strength or additional toughness depending on the intended application for the film.

In the production of polyolefins in general, it is known to add a wide variety of different additives for different purposes. For instance, it is known to add nucleating agents during the processing to improve the crystallisation and in particular in relation to improving clarity. Such nucleating agents may in this context be referred to as clarifying agents.

WO 2007/039471 A1 describes a process for improving the flow properties of a melt containing a thermoplastic polymer. The process comprises incorporating 0.005% to 0.5% by weight, relative to the weight of the thermoplastic polymer, of one or more additives selected from the group consisting of organic and inorganic compounds with needle-like morphology in their solid-state into the thermoplastic polymer prior to or during melt processing. The disclosure describes employing an additive which is an organic compound containing polar moieties and shielding nonpolar hydrophobic groups on the outer molecule sphere. The reference proposes as the additive a range of different multiple amide derivatives of aliphatic or aromatic polycarboxylic acids; multiple amide derivatives of aliphatic or aromatic polyamines; multiple amide derivatives of aliphatic or aromatic amino carboxylic acids; and sorbitol acetals.

EP 1674447 B1 discloses amide mixtures, polyolefin resin compositions and polyolefin resin moulded products. This document refers to an objective of providing a mixture of amide compounds which has improved thermal stability and alkali resistance, and which can produce a moulded product with further improved transparency, crystallizability (heat resistance) and rigidity. The reference is directed to a mixture of at least two amide based compounds having the general formula R¹—(CONHR²)ₐ, where a represents an integer of 2 to 6; R¹ is an aliphatic polycarboxylic acid; R² is a trans-2-alkylcyclohexylamine residue or a cis-2-alkylcyclohexylamine residue in which the trans-2-alkylcyclohexylamine residue accounts for at least 70% by mole of all of the 2-alkylcyclohexylamine residues contained in the mixture. The reference further describes a polyolefin resin composition containing the aforesaid mixture and mouldings of the compositions.

EP 2204408 A1 concerns a polyolefin having a high crystallisation temperature which is described as having excellent transparency. The polyolefin composition comprises 0.01 to 10 parts by mass of a methylenebisanilide compound.

U.S. Pat. No. 9,278,487 B1 discloses an extruded air-cooled blown film having a) a total thickness of 5 to 500 μm, b) a monolayer structure of 2 to 9 co-extruded layers, c) at least one layer containing a polymer selected from polypropylene homopolymers, polypropylene random copolymers, hetero phasic polypropylene block polymers, or any mixtures, and optionally d) a modulus according to EN ISO 527 enhanced by at least 10% versus a reference film without the nucleating agent. The polymer of the at least one layer has a melt flow rate, according to ASTM D-1238, of 0.1 to 10 dg/min at 230 °C and 2.16 kg. The layer further contains 0.001 to 2%, relative to the weight of the polymer, of a particular nucleating agent. The nucleating agents include compounds having 2 to 6 amide groups based on polycarboxylic acids, polyamines or amino carboxylic acids. The disclosure refers to clarified films containing polypropylene as principal component and improved stiffness of the blown films without impairing their elasticity.

WO 2017/156099 relates to trisamide compounds and compositions containing them. The trisamide compounds are based on benzenetrisamides in which at least one of the amide groups has a cyclohexyl substituent. They can be employed as functional substances for use with a broad range of materials, including glassy and semi crystalline polymers, elastomers, rubbers, thermosets. These trisamide compounds can be used by themselves or in combination with other functional substances and are said to enhance thermal, optical, electrical, cosmetic and other characteristics, mechanical properties of materials to which they are applied. The composition preferably includes a polymer which is a thermoplastic polymer, such as a polyolefin, polyester, polyamides, polylactic acid, polycarbonate, acrylic polymer, or mixtures. The preferred polymer is a polyolefin polymer such as polypropylene polymer, a polyethylene polymer, polymethylpentene polymer, a polybutylene polymer, a poly(vinyl cyclohexane) polymer.

WO 2012/045288 discloses a method of preparing nucleated semi-crystalline polyolefin by coordination polymerization. The nucleating agent is dosed in the form of the suspension or the solution in a nonpolar hydrocarbon solvent or in concentrated organoaluminium as part of the catalyst system for the alpha-olefin polymerization. Suitable nucleating agents include compounds based on benzene trisamides. The reference describes polymer suitable for in situ nucleation involves ethylene and propylene homopolymers as well as mutual copolymers.

WO 2004/072168 describes a composition containing a) a natural or synthetic polymer and b) one or more compounds based on benzene trisamide structures. The compositions are said to have excellent crystallizability, high transmittance, low haze and/or improved thermal stability. Examples of synthetic polymers are said to be polymers of monoolefins preferably being polyethylene and polypropylene.

An objective of the present invention is to provide improvements to melt strength and/or melt elasticity and/or the drawability of polyethylenes. In particular, there is a desire to improve melt strength and/or melt elasticity and/or drawability of polyethylene during processing, especially during the extrusion of polyethylene, and more especially during the extrusion of polyethylene to produce films or fibres. This would particularly be the case for blown ethylene film production. Such improvements are desirable for mono and biaxial orientated polyethylene films (BOPE).

### SUMMARY OF THE INVENTION

In accordance with the present invention, we provide a use of an additive for increasing the melt strength and/or melt elasticity and/or the drawability of a polyethylene, wherein the additive is selected from at least one compound selected from the group consisting of bisamides, trisamides, tetraamides and sorbitol acetals.

The invention also provides a method for increasing the melt strength and/or melt elasticity and/or the drawability of polyethylene by adding an additive to the polyethylene, wherein the additive is selected from the group consisting of bisamides, trisamides, tetraamides and sorbitol acetals.

Additionally provided in accordance with the present invention is a polyethylene of improved melt strength and/or melt elasticity and/or drawability, comprising an additive for increasing the melt strength and/or melt elasticity and/or the drawability of the polyethylene, which additive is selected from the group consisting of bisamides, trisamides, tetraamides and sorbitol acetals.

### DETAILED DESCRIPTION OF THE INVENTION

Inventors have found that compounds in the categories of bisamides, trisamides, tetraamides and sorbitol acetals can be used in the processing of polyethylene to achieve the aforementioned objectives. The incorporation of bisamides, trisamides, tetraamides or sorbitol acetals into the polyethylene processing can improve the melt strength as well after melt elasticity and can improve the drawability of the molten polyethylene.

The polyethylene may be any of ultrahigh molecular weight polyethylene (UHMWPE), ultra-low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE) or chlorinated polyethylene (CPE).

Preferably, the polyethylene has a density of from 0.915 to 0.960 g/cm³, preferably from 0.915 to 0.950 g/cm³.

Suitably the polyethylene may be an ultrahigh molecular weight polyethylene (UHMWPE). Such UHMWPE may have a molecular weight of several million, for instance from 3.5 to 7.5 million g/mol. Typically, the density tends to be less than high density polyethylene and may be in the range of from 0.930 to 0.935 g/cm³.

High density polyethylene (HDPE) may also be processed in accordance with the present invention, especially if the density does not exceed 0.960 g/cm³. Typically, HDPE has a density of greater than 0.941 g/cm³.

Another suitable polyethylene which may be processed according to the present invention includes low density polyethylene (LDPE). Low density polyethylene may be characterised by having a high degree of short and long chain branching. Typically, LDPE may have a density in the range of from 0.910 to 0.940 g/cm³. Where LDPE is been processed, desirably the density would be in the range of from 0.915 to 0.940 g/cm³.

More suitably the polyethylene employed in accordance with the present invention may be a medium density polyethylene (MDPE). Typically, such a medium density polyethylene (MDPE) may have a density in the range of from 0.926 to 0.940 g/cm³.

It is particularly preferred that the polyethylene is a linear low-density polyethylene (LLDPE). LLDPE may be characterised by being a substantially linear polymer but can have numerous short branches. The density of LLDPE is typically in the range of from 0.915 to 0.925 g/cm³.

In one preferred aspect according to the present invention, the additive is desirably a bisamide, a trisamide or a tetraamide of any of the formulae (IA), (IB), and (IC)

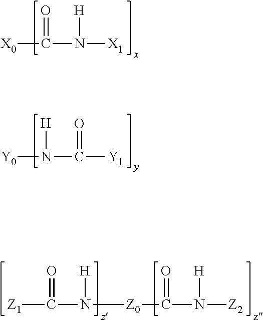

wherein
x and y are 2 or 3 or 4;
z′ and z″ independently of one another are 1 or 2 or 3 with the proviso that the sum of z′ and z″ is either 2 or 3 or 4;
X₀ is a residue which is formed by elimination of x carboxyl groups of a saturated or unsaturated aliphatic polycarboxylic acid having 3 to 25 carbon atoms, a residue which is formed by elimination of x carboxyl groups of a saturated or unsaturated alicyclic polycarboxylic acid having 7 to 25 carbon atoms or a residue which is formed by elimination of x carboxyl groups of an aromatic polycarboxylic acid having 8 to 25 carbon atoms; any of said polycarboxylic acids optionally contains further hetero atoms in its skeleton;
the radicals X₁ independently of one another are C₁-C₂₀ alkyl unsubstituted or substituted by one or more hydroxy, amino and/or nitro groups;
C₂-C₂₀ alkenyl unsubstituted or substituted by one or more hydroxy, amino and/or nitro groups;
C₂-C₂₀ alkyl interrupted by oxygen or sulfur;
C₃-C₁₂ cycloalkyl unsubstituted or substituted by one or more C₁-C₂₀ alkyl;
bis[C₃-C₁₂ cyclo alkyl]-C₁-C₁₀ alkyl unsubstituted or substituted by one or more C₁-C₂₀ alkyl;
a bicyclic or tricyclic hydrocarbon radical with 5 to 20 carbon atoms unsubstituted or substituted by one or more C₁-C₂₀ alkyl;
phenyl unsubstituted or substituted by one or more radicals selected from C₁-C₂₀ alkyl, C₁-C₂₀ alkoxy, C₁-C₂₀ alkylamino, di-(C₁-C₂₀ alkyl)amino, amino, hydroxy and nitro;
phenyl-C₁-C₂₀ alkyl unsubstituted or substituted by one or more radicals selected from C₁-C₂₀ alkyl, C₁-C₂₀ alkoxy, C₁-C₂₀ alkylamino, di-(C₁-C₂₀ alkyl)amino, amino, hydroxy and nitro;
phenylethenyl unsubstituted or substituted by one or more C₁-C₂₀ alkyl; biphenyl-(C₁-C₁₀ alkyl) unsubstituted or substituted by one or more C₁-C₂₀ alkyl;
naphthyl unsubstituted or substituted by one or more C₁-C₂₀ alkyl;
naphthyl-C₁-C₂₀ alkyl unsubstituted or substituted by one or more C₁-C₂₀ alkyl;
naphthoxymethyl and substituted or substituted by one or more C₁-C₂₀ alkyl;
biphenylenyl, fluorenyl, anthryl;
a 5 to 6 membered heterocyclic radical unsubstituted or substituted by one or more C₁-C₂₀ alkyl;
a C₁-C₂₀ hydrocarbon radical containing one or more halogen or pseudo-halogen;
tri(C₁-C₁₀ alkyl)silyl; or
tri(C₁-C₁₀ alkyl)silyl(C₁-C₁₀ alkyl);
Y₀ is a residue which is formed by elimination of y amino groups of a saturated or unsaturated aliphatic polyamine having 3 to 25 carbon atoms, a residue which is formed by elimination of y amino groups of a saturated or unsaturated alicyclic polyamine having 6 to 25 carbon atoms or a residue which is formed by elimination of y amino groups of an aromatic polyamine having 6 to 25 carbon atoms; any of said polyamines optionally contains further hetero atoms in its skeleton;
Z₀ is a residue which is formed by elimination of z′ amino groups and z″ carboxyl groups of an unsaturated or saturated aliphatic amino carboxylic acid having 2 to 25 carbon atoms, a residue which is formed by elimination of z′ amino groups and z″ carboxyl groups of a saturated or unsaturated alicyclic amino carboxylic acid having 7 to 25 carbon atoms or a residue which is formed by elimination of z′ amino groups and z″ carboxyl groups of an aromatic amino carboxylic acid having 7 to 25 carbon atoms; any of said amino carboxylic acids optionally contains further hetero atoms in its skeleton;
the radicals Z₁ and Z₂ independently of one another have the same definition given for X₁.

Examples of a saturated or unsaturated aliphatic polycarboxylic acid having 3 to 25, preferably 3 to 16, in particular 4 to 12, carbon atoms and x carboxyl groups and optionally containing further hetero atoms in its skeleton are malonic acid, diphenylmalonic acid, succinic acid, phenylsuccinic acid, diphenylsuccinic acid, glutaric acid, 3,3-dimethylglutaric acid, adipic acid, pimelic acid, suberic acid, azelaic acid, sebacic acid, 1,12-dodecanedioic acid, 1,14-tetradecanedioic acid, 1, 18-octadecanedioic acid, citric acid, methanetricarboxylic acid, tricarballylic acid, propenetricarboxylic acid, pentanetricarboxylic acid, ethanetetracarboxylic acid, propanetricarboxylic acid (particularly 1, 2, 3-propanetricarboxylic acid), propanetetracarboxylic acid, pentanetetracarboxylic acid, butanetetracarboxylic acid (particularly 1,2,3,4-butanetetracarboxylic acid), dodecanetetracarboxylic acid, ethylenediaminetetraacetic acid, nitrilotriacetic acid, ethyleneglycolbis[beta-aminoethylether]N,N,N′,N′-tetraacetic acid, N-hydroxyethylethylenediamine-N,N′,N′-triacetic acid, 1,3-diaminopropane-2-ol-N,N,N′,N′-tetraacetic acid, 1,2-diaminopropane-N,N,N′,N′-tetraacetic acid, nitrilotripropionic acid, 1,6-hexanediaminetetraacetic acid, N-(2-carboxyethyl)iminodiacetic acid and the like.

Examples of a saturated or unsaturated alicyclic polycarboxylic acid having 7 to 25, preferably 8 to 16, carbon atoms and x carboxyl groups and optionally containing further hetero atoms in its skeleton are 1,2-cyclohexane dicarboxylic acid, 1,4-cyclohexanedicarboxylic acid, 1,4-cyclohexanediacetic acid, cyclohexanetricarboxylic acid, cyclobutanetetracarboxylic acid, cyclopentanetetracarboxylic acid, cyclohexanetetracarboxylic acid, tetrahydrofurantetracarboxylic acid, 5-(succinic acid)-3-methyl-3-cylohexene-1,2-dicarboxylic acid, bicyclo[2,2,2]octa-7-ene-2,3,5,6-tetracarboxylic acid, 5,6,9,10-tetracarboxytricyclo[6.2.2.0.sup.2,7]dodeca-2,11-diene which may have a lower alkyl group as a substituent (such as a methyl group at the 3-, 8- 11- or 12-position), 1,2-cyclohexanediaminetetraacetic acid, 2,3,5-tricarboxycyclopentylacetic acid, 6-methyl-4-cyclohexene-1,2,3-tricarboxylic acid, 3,5,6-tricarboxynorbornene-2-acetic acid, thiobis(norbornene-2,3-dicarboxylic acid), bicyclo[4.2.0]octane-3,4,7,8-tetracarboxylic acid, 1,1′-bicyclopropane-2,2′,3,3′-tetracarboxylic acid, 1,2-bis(2,3-dimethyl-2,3-dicarboxycyclobutyl)ethane, pyrazine-2,3,5,6-tetracarboxylic acid, tricyclo[4.2.2.0.sup.2,5]decane-9-ene-3,4,7,8-tetracarboxylic acid, 3,4-dicarboxy-1,2,3,4-tetrahydro-1-naphthalenesuccinic acid which may have a lower alkyl group as a substituent (such as a methyl group at the 1-, 5-, 6- or 7-position), 2,3,4,5,6,7,12,13-octahydrophenanthrene-3,4,5,6-tetracarboxylic acid and the like.

Examples of an aromatic polycarboxylic acid having 8 to 25, preferably 8 to 22, in particular 8 to 17, carbon atoms and x carboxyl groups and optionally containing further hetero atoms in its skeleton are p-phenylenediacetic acid, p-phenylenediethanoic acid, phthalic acid, 4-tert-butylphthalic acid, isophthalic acid, 5-tert-butylisophthalic acid, terephthalic acid, 1,8-naphthalic acid, 1,4-naphthalenedicarboxylic acid, 2,6-naphthalenedicarboxylic acid, 2,7-naphthalenedicarboxylic acid, diphenic acid, 3,3′-biphenyldicarboxylic acid, 4,4′-biphenyldicarboxylic acid, 4,4′-binaphthyldicarboxylic acid, bis(3-carboxyphenyl)methane, bis(4-carboxyphenyl)methane, 2,2-bis(3-carboxyphenyl)propane, 2,2-bis(4-carboxyphenyl)propane, 3,3′-sulfonyldibenzoic acid, 4,4, -sulfonyldibenzoic acid, 3,3′-oxydibenzoic acid, 4,4′-oxydibenzoic acid, 3,3′-carbonyldibenzoic acid, 4,4′-carbonyldibenzoic acid, 3,3′-thiodibenzoic acid, 4,4′-thiodibenzoic acid, 4,4′-(p-phenylenedioxy)dibenzoic acid, 4,4′-isophthaloyldibenzoic acid, 4,4′-terephthaloyldibenzoic acid, dithiosalicylic acid, benzenetricarboxylic acid such as trimesic acid, benzenetetracarboxylic acid, benzophenonetetracarboxylic acid, biphenyltetracarboxylic acid, diphenylethertetracarboxylic acid, diphenylsulfonetetracarboxylic acid, diphenylmethanetetracarboxylic acid, perylenetetracarboxylic acid, naphthalenetetracarboxylic acid, 4,4′-dinaphthalic acid, benzidine-3,3′-dicarboxyl-N,N′-tetraacetic acid, diphenylpropanetetracarboxylic acid, anthracenetetracarboxylic acid, phthalocyaninetetracarboxylic acid, ethyleneglycol-trimellitic acid diester, benzenehexacarboxylic acid, glycerine-trimellitic acid triester and so on.

Examples of linear or branched alkyl having up to 20 carbon atoms and being optionally substituted by one or more hydroxy, amino and/or nitro groups are ethyl, n-propyl, 1-methylethyl, n-butyl, 2-methylpropyl, 1-methylpropyl, tert-butyl, pentyl, 1-methylbutyl, 2-methylbutyl, 3-methylbutyl, 1,1-dimethylpropyl, 1-ethylpropyl, tert-butylmethyl, hexyl, 1-methylpentyl, heptyl, isoheptyl, 1-ethylhexyl, 2-ethylpentyl, 1-propylbutyl, octyl, nonyl, isononyl, neononyl, 2,4,4-trimethylpentyl, undecyl, tridecyl, pentadecyl, heptadecyl, hydroxymethyl, 1-hydroxyethyl and 1-aminoethyl. Branched C₃-C₁₀alkyl is particularly preferred. One of the preferred meanings of the radicals X₁, Y₁, Z₁ and Z² is branched C₃-C₁₀ alkyl with a quaternary C atom in position 1, in particular —C(CH₃)₂—H or —C(CH₃)₂—(C₁-C₇alkyl).

Examples of C₂-C₂₀alkyl interrupted by oxygen or sulfur are t-butoxymethyl, t-butoxyethyl, t-butoxypropyl, t-butoxybutyl, (H₃C)₃C—S—CH₂—, (H₃C)₃C—S—C₂H₄—, (H₃C)₃C—S—C₃H₅— and (H₃C)₃C—S—C₄H₈—.

Examples of C₁-C₈alkoxy are methoxy, ethoxy, propoxy, butoxy, pentyloxy, hexyloxy, heptyloxy and octyloxy. Methoxy is particularly preferred.

Examples of C₁-C₈alkylthio are methylthio, ethylthio, propylthio, butylthio, pentylthio, hexylthio, heptylthio and octylthio.

Examples of C₁-C₈alkylsulfoxy are methylsulfoxy, ethylsulfoxy, propylsulfoxy, butylsulfoxy, pentylsulfoxy, hexylsulfoxy, heptylsulfoxy and octylsulfoxy.

Examples of C₁-C₂₀alkenyl unsubstituted or substituted by one or more hydroxy, amino and/or nitro groups are 9-decenyl, 8-heptadecenyl, 11-hydroxy-8-heptadecenyl and 11-amino-8-heptadecenyl.

Examples of C₃-C₁₂cycloalkyl unsubstituted or substituted by one or more C₁-C₂₀alkyl, e.g. 1, 2, 3 or 4 C₁-C₄alkyl, are cyclopropyl, 3-methylcyclopropyl, 2,2,3,3-tetramethylcyclopropyl, cyclobutyl, cyclopentyl, cyclohexyl, 1-methylcyclohexyl, 2-methylcyclohexyl, 3-methylcyclohexyl, 4-methylcyclohexyl, 4-tert-butylcyclohexyl and cycloheptyl.

An example of bis[C₃-C₁₂cycloalkyl]-C₁C₁₀alkyl unsubstituted or substituted by one or more C₁-C₂₀alkyl, e.g. 1, 2 or 3 C₁-C₄alkyl, is dicyclohexylmethyl.

Examples of a bicyclic or tricyclic hydrocarbon radical with 5 to 20 carbon atoms unsubstituted or substituted by one or more C₁-C₂₀alkyl, e.g. 1, 2 or 3 C₁-C₄alkyl, are

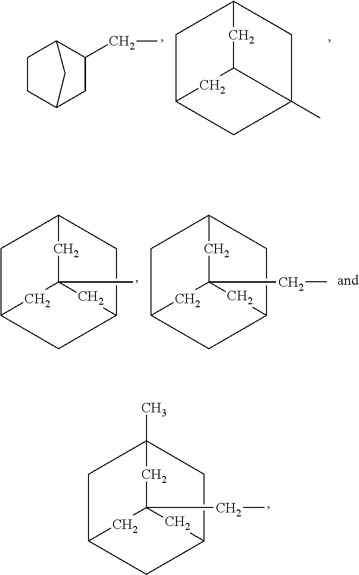

Examples of phenyl unsubstituted or substituted by one or more radicals selected from C₁-C₂₀alkyl, C₁-C₂₀alkoxy, C₁-C₂₀alkylamino, di(C₁-C₂₀alkyl)amino, amino, hydroxy and nitro, preferably C₁-C₄alkyl, C₁-C₄alkoxy, C₁-C₄alkylamino, di(C₁-C₄alkyl)amino, hydroxy and nitro, are phenyl, 3-methylphenyl, 3-methoxyphenyl, 4-methylphenyl, 4-ethylphenyl, propylphenyl, 4-isopropylphenyl, 4-tert-butylphenyl, 4-isopropoxyphenyl, 2,3-dimethoxyphenyl, 2-nitrophenyl, 3-methyl-6-nitrophenyl, 4-dimethylaminophenyl, 2,3-dimethylphenyl, 2,6-dimethylphenyl, 2,4-dimethylphenyl, 3,4-dimethylphenyl, 3,5-dimethylphenyl, 3,5-di-tert-butylphenyl, 2,4,6-trimethylphenyl and 3,5-di-tert-butyl-4-hydroxyphenyl.

Examples of phenyl-C₁-C₂₀alkyl unsubstituted or substituted by one or more radicals selected from C₁-C₂₀alkyl, C₃-C₁₂cycloalkyl, phenyl, C₁-Czoalkoxy, amino, hydroxy and nitro, preferably C₁-C₄alkyl, C₃-C₅cycloalkyl, phenyl, C₁-C₄alkoxy and hydroxy, are benzyl, α-cyclohexylbenzyl, diphenylmethyl, 1-phenylethyl, α-hydroxybenzyl, 2-phenylethyl, 2-phenylpropyl, 3-phenylpropyl, 3-methylbenzyl, 3,4-dimethoxybenzyl and 2-(3,4-dimethoxyphenyl)ethyl.

An example of phenylethenyl unsubstituted or substituted by one or more C₁-C₂₀alkyl, e.g. 1, 2 or 3 C₁-C₄alkyl, is 2-(4-methylphenyl) ethenyl.

An example of biphenyl-(C₁-C₁₀alkyl) unsubstituted or substituted by one or more C₁-C₂₀alkyl, e.g. 1, 2 or 3 C₁-C₄alkyl, is 4-biphenylmethyl.

Examples of naphthyl unsubstituted or substituted by one or more C₁-C₂₀alkyl, e.g. 1, 2 or 3 C₁-C₄alkyl, are 1-naphthyl and 2-naphthyl.

Examples of naphthyl-C₁-C₂₀alkyl unsubstituted or substituted by one or more C₁-C₂₀alkyl, e.g. 1, 2 or 3 C₁-C₄alkyl, are 1-naphthylmethyl and 2-naphthylmethyl.

An example of naphthoxymethyl unsubstituted or substituted by one or more C₁-C₂₀alkyl, e.g. 1, 2 or 3 C₁-C₄alkyl, is 1-naphthoxymethyl.

An example of biphenylenyl, fluorenyl or anthryl is 2-biphenylenyl, 9-fluorenyl, 1-fluorenyl or 9-anthryl, respectively.

Examples of a 5- to 6-membered heterocyclic radical unsubstituted or substituted by one or more C₁-C₂₀alkyl, e.g. 1, 2 or 3 C₁-C₄alkyl, are 3-pyridinyl, 4-pyridinyl, 2-hydroxypyridin-3-yl, 3-quinolinyl, 4-quinolinyl, 2-furyl, 3-furyl and 1-methyl-2-pyrryl.

Examples of a C₁-C₂₀hydrocarbon radical containing one or more halogen or pseudo halogen, e.g. 1, 2, 3, 4, 5, or 6-F, -Cl or -I, are 1-bromo-2-methylpropyl, dichloromethyl, pentafluoroethyl, 3,5-bis[trifluoromethyl]phenyl, 2,3,5,6-tetrafluoro-p-tolyl, 2,3-dichlorophenyl, 3,4-dichlorophenyl and 2,4-bis[trifluoromethyl]phenyl.

An example of tri(C₁-C₁₀alkyl)silyl is (H₃C)₃Si—.

An example of tri(C₁-C₁₀alkyl)silyl(C₁-C₁₀alkyl) is (H₃C)₃Si—(CH₂)₂—.

Examples of a saturated or unsaturated aliphatic polyamine having 3 to 25 carbon atoms and y amino groups and optionally containing further hetero atom in its skeleton are 1,3-diaminopropane, 1,4-diaminobutane and 1,5-diaminopentane.

Examples of a saturated or unsaturated alicyclic polyamine having 6 to 25, preferably 6 to 13, carbon atoms and y amino groups and optionally containing further hetero atom in its skeleton are 1,2-diaminocyclohexane, 1,4-diaminocyclohexane, 4,4′-diaminodicyclohexyl, 4,4′-diamino-3,3′-dimethyldicyclohexyl, 4,4′-diaminodicyclohexylmethane, 4,4′-diamino-3,3′ dimethyldicyclohexylmethane, 1,3-bis(aminomethyl)cyclohexane, 1,4-bis(aminomethyl)cyclohexane, isophoronediamine, menthenediamine, melamine, 1,3,5-triaminocyclohexane, 1,2,4-triaminocyclohexane, 1,2,4,5-tetraaminocyclohexane and the like.

Examples of an aromatic polyamine having 6 to 25, preferably 6 to 17, in particular 6 to 13, carbon atoms and y amino groups and optionally containing further hetero atoms in its skeleton are o-phenylenediamine, m-phenylenediamine, p-phenylenediamine, 2,3-diaminotoluene, 2,4-diaminotoluene, 2,6-diaminotoluene, 3,4-diaminotoluene, 4,6-dimethyl-m-phenylenediamine, 2,5-dimethyl-p-phenylenediamine, 4,5-dimethyl-o-phenylenediamine, 2,4-diaminomesitylene, 2,3-diaminopyridine, 2,6-diaminopyridine, 3,4-diaminopyridine, 1,5-diaminonaphthalene, 1,8-diaminonaphthalene, 2,3-diaminonaphthalene, 2,7-diaminonaphthalene, 9,10-diaminophenanthrene, 3,3′,5,5′-tetramethylbenzidine, 3,3′ dimethyl-4,4′-diaminobiphenyl, 3,3′-dimethoxy-4,4′-diaminobiphenyl, 4,4′-diaminodiphenylmethane, 3,3′-diaminodiphenylmethane, 3,4′-diaminodiphenylmethane, 4,4′ methylenedi-o-toluidine, 4,4′-methylenedi-2,6-xylidine, 4,4′-methylenedi-2,6-diethylaniline, 4,4′-diamino-1,2-diphenylethane, 4,4′-diamino-2,2′-dimethylbibenzyl, 4,4′-diaminostilbene, 3,4′-diamino-2,2-diphenylpropane, 4,4′-diamino-2,2-diphenylpropane, 4,4′ diaminodiphenylether, 3,4′-diaminodiphenylether, 4,4′-thiodianiline, 2,2′-dithiodianiline, 4,4′-dithiodianiline, 3,3′-diaminodiphenylsulfone, 4,4′-diaminodiphenylsulfone, 3,3′-diaminobenzophenone, 4,4′-diaminobenzophenone, 4,4′-diaminobenzanilide, o-tolidinesulfone, 2,7-diaminofluorene, 3,7-diamino-2-methoxyfluorene, bis-p aminophenylaniline, 1,3-bis(4-aminophenylpropyl)benzene, 1,4-bis(4-aminophenylpropyl)benzene, 1,3-bis(4-aminophenoxy)benzene, 1,4-bis(4-aminophenoxy)benzene, 4,4′-bis(4-aminophenoxy) biphenyl, bis[4-(4-aminophenoxy)phenyl]ether, bis[4-(4-aminophenoxy)phenyl]sulfone, 9,9-bis(4-aminophenyl)fluorene-1,2,4,5-tetraaminobenzene, 1,3,5-triaminobenzene, 1,2,4-triaminobenzene, Para Rosaniline, 2,4,6-triaminophenol, 3,3′-diaminobenzidine, tris(4-aminophenyl) methane, 2,4,6-triaminopyrimidine, and the like.

Examples of an unsaturated or saturated aliphatic amino carboxylic acid having 2 to 25, preferably 2 to 12, in particular 2 to 5, carbon atoms, z′ amino groups and z″ carboxyl groups and optionally containing further hetero atoms in its skeleton are aminoacetic acid, alpha-aminopropionic acid, beta-aminopropionic acid, alpha-aminoacrylic acid, alpha-aminobutyric acid, beta-aminobutyric acid, gamma-aminobutyric acid, alpha-amino-alpha-methylbutyric acid, gamma-amino-alpha-methylbutyric acid, alpha-aminoisobutyric acid, beta aminoisobutyric acid, alpha-amino-n-valeric acid, delta-amino-n-valeric acid, beta-aminocrotonic acid, alpha-amino-beta-methylvaleric acid, alpha-aminoisovaleric acid, 2-amino-4-pentenoic acid, alpha-amino-n-caproic acid, 6-aminocaproic acid, alpha-aminoisocaproic acid, 7-aminoheptanoic acid, alpha-amino-n-caprylic acid, 8-aminocaprylic acid, 9-aminononanoic acid, 11-aminoundecanoic acid, 12-aminododecanoic acid, 2-aminoadipic acid, arginine, asparagine, aspartic acid, cystine, glutamic acid, glutamine, ornithine, creatine, aminomalonic acid, and the like.

Examples of a saturated or unsaturated alicyclic amino carboxylic acid having 7 to 25, preferably 7 to 9, carbon atoms, z′ amino groups and z″ carboxyl groups and optionally containing further hetero atoms in its skeleton care 1-aminocyclohexanecarboxylic acid, 2-aminocyclohexanecarboxylic acid, 3-aminocyclohexanecarboxylic acid, 4-aminocyclohexanecarboxylic acid, p-aminomethylcyclohexanecarboxylic acid, 2-amino-2-norbornanecarboxylic acid, 3,5-diaminocyclohexanecarboxylic acid, 1-amino-1,3-cyclohexanedicarboxylic acid and the like.

Examples of an aromatic amino carboxylic acid having 7 to 25, preferably 7 to 15, in particular 7 to 11, carbon atoms, z′ amino groups and z″ carboxyl groups and optionally containing further hetero atoms in its skeleton are alpha-aminophenylacetic acid, alpha-amino-beta-phenylpropionic acid, 2-amino-2-phenylpropionic acid, 3-amino-3-phenylpropionic acid, alpha-amino cinnamic acid, 2-amino-4-phenylbutyric acid, 4-amino-3-phenylbutyric acid, anthranilic acid, m-aminobenzoic acid, p-aminobenzoic acid, 2-amino-4-methylbenzoic acid, 2-amino-6-methylbenzoic acid, 3-amino-4-methylbenzoic acid, 2-amino-3-methylbenzoic acid, 2-amino-5-methylbenzoic acid, 4-amino-2-methylbenzoic acid, 4-amino-3-methylbenzoic acid, 2-amino-3-methoxybenzoic acid, 3-amino-4-methoxybenzoic acid, 4-amino-2-methoxybenzoic acid, 4-amino-3-methoxybenzoic acid, 2-amino-4,5-dimethoxybenzoic acid, o-aminophenylacetic acid, m-aminophenylacetic acid, p-aminophenylacetic acid, 4-(4-aminophenyl) butyric acid, 4-aminomethylbenzoic acid, 4-aminomethylphenylacetic acid, o-aminocinnamic acid, m-aminocinnamic acid, p-aminocinnamic acid, p-aminohippuric acid, 2-amino-1-naphthoic acid, 3-amino-1-naphthoic acid, 4-amino-1-naphthoic acid, 5-amino-1-naphthoic acid, 6-amino-1-naphthoic acid, 7-amino-1-naphthoic acid, 8-amino-1-naphthoic acid, 1-amino-2-naphthoic acid, 3-amino-2-naphthoic acid, 4-amino-2-naphthoic acid, 5-amino-2-naphthoic acid, 6-amino-2-naphthoic acid, 7-amino-2-naphthoic acid, 8-amino-2-naphthoic acid, 3,5-diaminobenzoic acid, 3,5-dicarboxyaniline, 4,4′diamino-3,3′-dicarboxydiphenylmethane and the like.

Examples of halogen or pseudo-halogen are —F, —Cl, —Br, —I, —CN, —CNO, —OCN, —SCN and —CNS.

In one desirable embodiment the additive is a trisamide or a tetraamide according to formula (IA). In this desirable embodiment
x is an integer of 3 or 4;
X₀ is a residue obtained by removing all of the carboxyl groups from 1,2,3-propanetricarboxylic acid or 1,2,3,4-butanetetracarboxylic acid; and
X₁ is represented by the formula (ID)

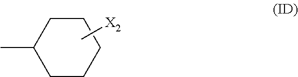

and the three or four X₂s are the same or different, and each independently represent a hydrogen atom or a C₁-C₁₀, linear or branched alkyl group. Examples of a C₁-C₁₀, linear or branched alkyl group include methyl, ethyl, n-propyl, 1-methylethyl, n-butyl, 2-methylpropyl, 1-methylpropyl, tert-butyl, pentyl, 1-methylbutyl, 2-methylbutyl, 3-methylbutyl, 1,1-dimethylpropyl, 1-ethylpropyl, tert-butylmethyl, hexyl, 1-methylpentyl, heptyl, isoheptyl, 1-ethylhexyl, 2-ethylpentyl, 1-propylbutyl, octyl, nonyl, isononyl, neononyl and 2,4,4-trimethylpentyl.

Preferably the additive is an aromatic bisamide, an aromatic trisamide or an aromatic tetraamide.

In a preferred embodiment, the additive is a bisamide, a trisamide or a tetraamide according to any of the formulae (IA), (IB), and (IC). In one such preferred embodiment x, y or the sum of z′ and z″ are 2, X₀, Y₀, and Z₀ are the group of the formula (II), (III), (IV A) or (IV B)

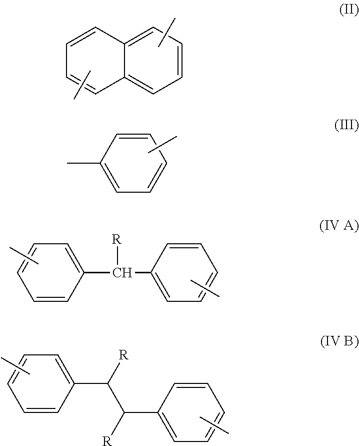

wherein R represents a hydrogen atom, C₁-C₄ alkyl which is optionally substituted or branched, C₃-C₁₂ cycloalkyl which is optionally substituted, or C₆-C₂₀ aryl which is optionally substituted.

Examples of C₁-C₄ alkyl include methyl, ethyl, n-propyl, 1-methylethyl, n-butyl, 2-methylpropyl, 1-methylpropyl and tert-butyl. Examples of C₃-C₁₂cycloalkyl optionally substituted include cyclopropyl, 3-methylcyclopropyl, 2,2,3,3-tetramethylcyclopropyl, cyclobutyl, cyclopentyl, cyclohexyl, 1-methylcyclohexyl, 2-methylcyclohexyl, 3-methylcyclohexyl, 4-methylcyclohexyl, 4-tert-butylcyclohexyl and cycloheptyl. Examples of C₆-C₂₀ aryl which is optionally substituted include phenyl, 3-methylphenyl, 3-methoxyphenyl, 4-methylphenyl, 4-ethylphenyl, propylphenyl, 4-isopropylphenyl, 4-tert-butylphenyl, 4-isopropoxyphenyl, 2,3-dimethoxyphenyl, 2-nitrophenyl, 3-methyl-6-nitrophenyl, 4-dimethylaminophenyl, 2,3-dimethylphenyl, 2,6-dimethylphenyl, 2,4-dimethylphenyl, 3,4-dimethylphenyl, 3,5-dimethylphenyl, 3,5-di-tert-butylphenyl, 2,4,6-trimethylphenyl and 3,5-di-tert-butyl-4-hydroxyphenyl, benzyl, α-cyclohexylbenzyl, diphenylmethyl, 1-phenylethyl, α-hydroxybenzyl, 2-phenylethyl, 2-phenylpropyl, 3-phenylpropyl, 3-methylbenzyl, 3,4-dimethoxybenzyl and 2-(3,4-dimethoxyphenyl)ethyl, 2-(4-methylphenyl) ethenyl, 4-biphenylmethyl, naphthyl, 1-naphthyl, 2-naphthyl, 1-naphthylmethyl, 2-naphthylmethyl, 1-naphthoxymethyl, 2-biphenylenyl, 9-fluorenyl, 1-fluorenyl and 9-anthryl.

One group of particularly suitable additives is aromatic bisamides based on formula (VI):

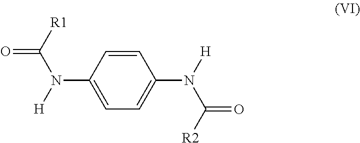

wherein R¹ and R² are each independently selected from C₁-C₅ linear or branched alkyl or substituted or unsubstituted C₃-C₆ cycloalkyl, preferably R1 and R2 both being tertiary butyl. In this case, R1 and R2 represent each Y₁ of formula (IB).

One preferred compound according to formula (II) is the compound of formula (XI).

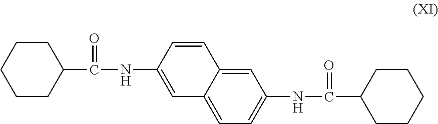 [SMILES: O=C(Nc1ccc2cc(NC(=O)C3CCCCC3)ccc2c1)C1CCCCC1]

One preferred compound according to formula (VI) is the compound of formula (XII).

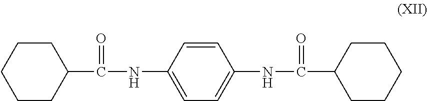 [SMILES: O=C(Nc1ccc(NC(=O)C2CCCCC2)cc1)C1CCCCC1]

One preferred compound according to formula (IV A) is the compound of formula (XIII).

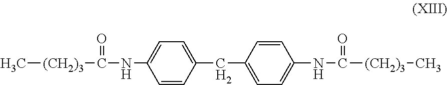

Another preferred compound according to formula (IV A) is the compound of formula (XIV).

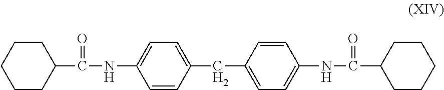 [SMILES: O=C(Nc1ccc(Cc2ccc(NC(=O)C3CCCCC3)cc2)cc1)C1CCCCC1]

In a preferred embodiment, the additive is a trisamide according to any of the formulae (IA), (IB), and (IC). In one such preferred embodiment x, y or the sum of z′ and z″ are 3, X₀, Y₀, and Z₀ are the group of the formula (V)

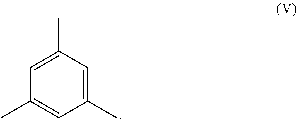

More preferred embodiments according to formula (V) include compounds according to the structures (V A), (V B), (V C) or (V D).

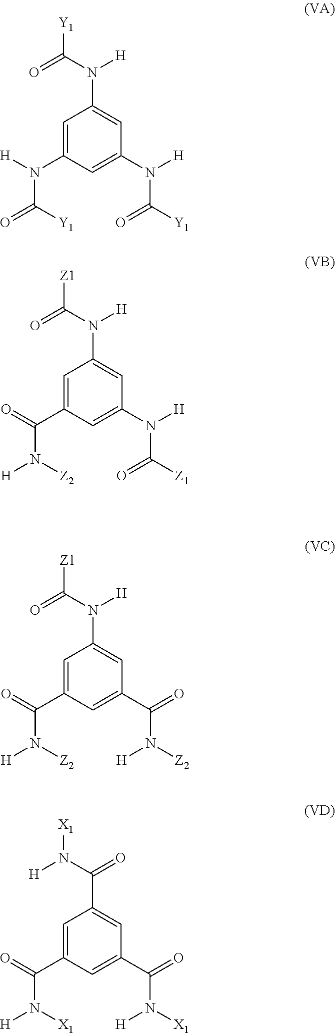

wherein each X₁, each Y₁, each Z₁ and each Z₂ independently of one another have the same meanings ascribed to them as previously provided.

Preferably, the additive is a bisamide or a trisamide of formula (IB) wherein when the additive is a bisamide Y₀ is represented by formula (III) or formula (II) and when the additive is a trisamide Y₀ is represented by formula (V).

More preferably, the additive is a trisamide of formula (IB) wherein Y₀ is represented by formula (V). It is particularly preferred that the additive is an aromatic trisamide of formula (VII),

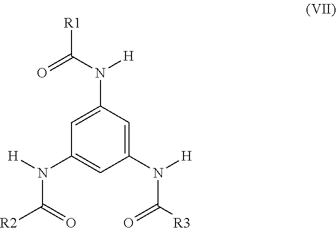

in which R1, R2 and R3 each independently selected from C₁-C₅ linear or branched alkyl or substituted or unsubstituted C₃-C₆ cycloalkyl, preferably R1, R2 and R3 all being tertiary butyl. In this case, R1, R2 and R3 represent each Y₁ of formula (IB).

In one desirable embodiment R1 is a substituted cyclohexyl group. Suitably R1 has the structure shown in formula (VII A):

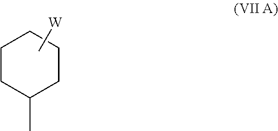

wherein W may be selected from C₁-C₁₀ linear or branched substituted or unsubstituted alkyl and may be in any substitution position of the cyclohexyl group, preferably in the para-position. In this instance R2 and R3 would have the same definitions given for the structure of formula (VII). Preferably, W is located in the para-position and is in the cis-position relative to the bond of the carbonyl carbon attached to the cyclohexanediyl ring. Preferably, W is located in the para-position and is in the trans-position relative to the bond of the carbonyl carbon attached to the cyclohexanediyl ring.

In a further preferred embodiment R2 has independently of R1 the same definition as ascribed to R1 as represented by formula (VII A).

In a still further preferred embodiment both R2 and R³ independently of each other and R1 have the same definition as ascribed to R1 as represented by formula (VII A).

Thus, according to the still further preferred embodiment the additive is an aromatic trisamide having the formula (VII B):

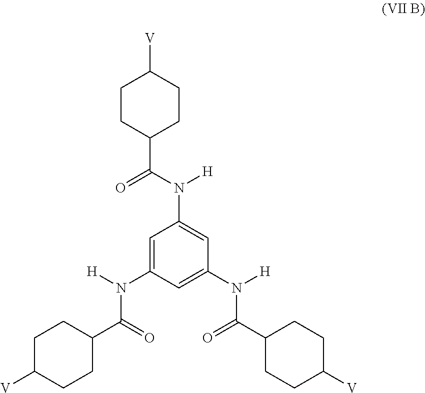

wherein each V group is independently selected from C₁-C₅ linear or branched alkyl, preferably C₃ or C₄ branched alkyl, more preferably the V groups all being tertiary butyl.

One specific suitable compound according to formula (VII B) is 1,3,5-tris[cis-4-tert-butylcyclohexylcarbonylamino]benzene, illustrated by formula (XV):

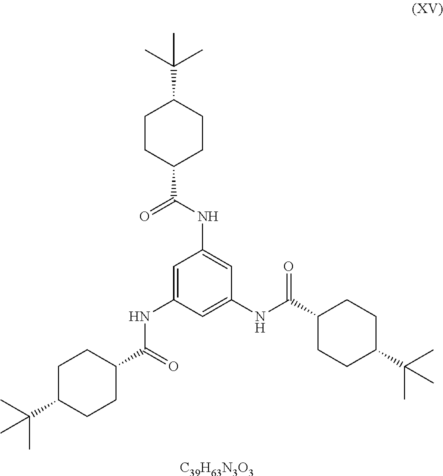 [SMILES: CC(C)(C)[C@H]1CC[C@@H](C(=O)Nc2cc(NC(=O)[C@H]3CC[C@@H](C(C)(C)C)CC3)cc(NC(=O)[C@H]3CC[C@@H](C(C)(C)C)CC3)c2)CC1 ; "C39H63N3O3"]

Another specific suitable compound according to formula (VII B) is trans-4-tert-butylcyclohexylcarbonylamino-3,5-bis[cis-4-tert-butylcyclohexylcarbonylamino]benzene, illustrated by formula (XVI):

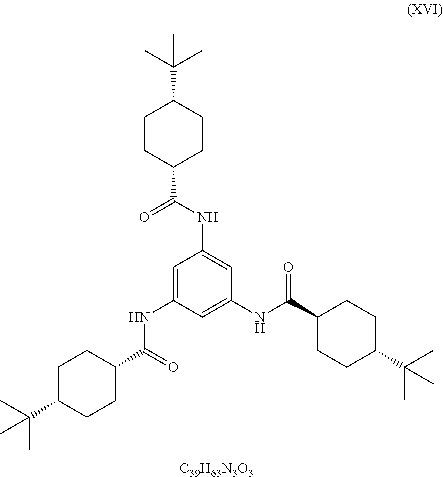 [SMILES: CC(C)(C)[C@H]1CC[C@@H](C(=O)Nc2cc(NC(=O)[C@H]3CC[C@@H](C(C)(C)C)CC3)cc(NC(=O)[C@H]3CC[C@H](C(C)(C)C)CC3)c2)CC1 ; "C39H63N3O3"]

A further specific suitable compound according to formula (VII B) is cis-4-tert-butylcyclohexylcarbonylamino-3,5-bis[trans-4-tert-butylcyclohexylcarbonylamino] benzene, illustrated by formula (XVII):

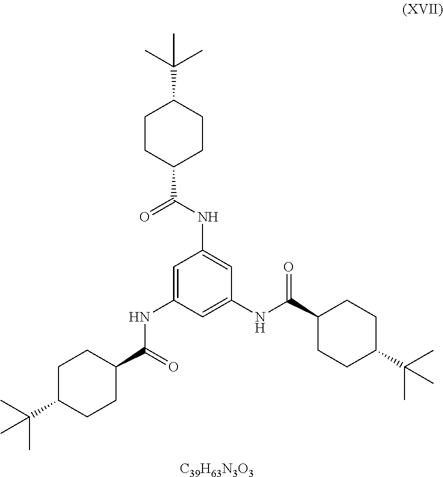 [SMILES: CC(C)(C)[C@H]1CC[C@@H](C(=O)Nc2cc(NC(=O)[C@H]3CC[C@H](C(C)(C)C)CC3)cc(NC(=O)[C@H]3CC[C@H](C(C)(C)C)CC3)c2)CC1 ; "C39H63N3O3"]

A still further specific suitable compound according to formula (VII B) is 1,3,5-tris[trans-4-tert-butylcyclohexylcarbonylamino]benzene, illustrated by formula (XVIII):

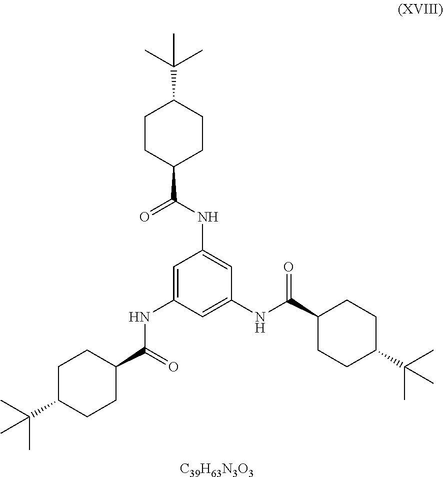 [SMILES: CC(C)(C)[C@H]1CC[C@H](C(=O)Nc2cc(NC(=O)[C@H]3CC[C@H](C(C)(C)C)CC3)cc(NC(=O)[C@H]3CC[C@H](C(C)(C)C)CC3)c2)CC1 ; "C39H63N3O3"]

Additional specific suitable compounds according to formula (VII B) are 1,3,5-tris[cis-4-iso-propycyclohexylcarbonylamino]benzene, trans-4-iso-propylylcyclohexylcarbonylamino-3,5-bis[cis-4-iso-propylcyclohexylcarbonylamino] benzene, trans-4-iso-propylcyclohexylcarbonylamino-3,5-bis[cis-4-iso-propyl cyclohexylcarbonylamino]benzene and 1,3,5-tris[trans-4-iso-propylcyclohexyl carbonylamino]benzene.

As indicated above the preferred embodiment of compounds of formula (VII) are where R1, R2 and R3 are all tertiary butyl. Such particularly preferred compound has the structure according to formula (XIX).

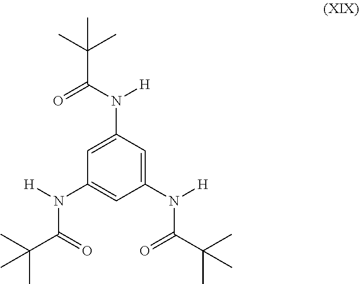 [SMILES: CC(C)(C)C(=O)Nc1cc(NC(=O)C(C)(C)C)cc(NC(=O)C(C)(C)C)c1]

In a further embodiment of the present invention the additive may desirably be a sorbitol acetal. Preferably the sorbitol acetal is a compound based on formula (VIII):

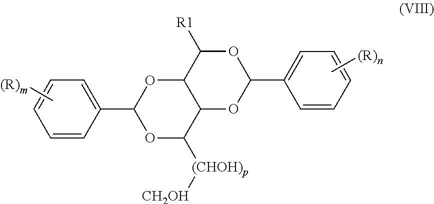

wherein
p is zero or 1;
m and n independently of one another are an integer from 0 to 3;
each radical R independently one another are C₁-C₈ alkyl, C₁-C₈ alkoxy, hydroxy, halogen, pseudo-halogen, C₁-C₈ alkylthio, C₁-C₈ alkylsulfoxy or 2 radicals R form together with two adjacent carbon atoms of the unsaturated parent ring a 5 to 7 membered carbocyclic or heterocyclic ring and R1 is selected from hydrogen or C₁-C₃ alkyl. Examples of halogen or pseudo-halogen are —F, —Cl, —Br, —I, —CN, —CNO, —OCN, —SCN and —CNS.

One such example of a compound according to formula (VIII) includes two radicals R forming together with two adjacent carbon atoms of the unsaturated parent ring a 5 to 7-membered carbocyclic or heterocyclic ring is represented by formula (XX):

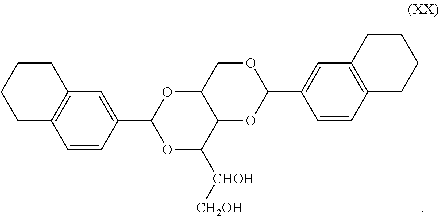

One particularly suitable sorbitol acetal based on formula (VIII) is the compound of formula (IX):

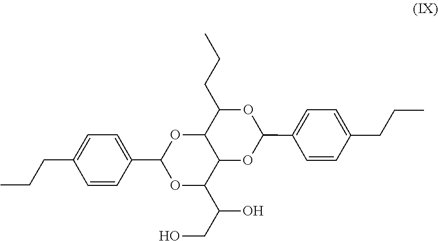 [SMILES: CCCc1ccc(C2OC(C(O)CO)C3OC(c4ccc(CCC)cc4)OC(CCC)C3O2)cc1]

Another particularly suitable sorbitol acetal based on formula (VIII) is the compound of formula (X):

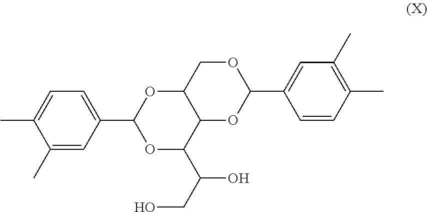

The additive may be added to the polyethylene melt in any suitable amount. Preferably the polyethylene comprises the additive in an amount of from 0.001 to 1.0%, suitably from 0.002 to 0.75% weight of additive to weight of polyethylene, preferably from 0.005 to 0.5%. One particularly suitable range may for instance be from 0.005 to 0.05%. Another particularly suitable range may be for instance from 0.05 to 0.5%. Bisamides, trisamides and tetraamides may suitably be added in any of these ranges. Preferably, however, bisamides, trisamides and tetraamides may be added in the range from 0.005 to 0.1% more preferably from 0.005 to 0.02%. Sorbitol acetals may suitably be added in any of these ranges. Preferably, however, sorbitol acetals may be added in the range from 0.1 to 0.6%, more preferably from 0.15 to 0.5%.

The polyethylene produced according to the present invention may be produced as a polyethylene film, a polyethylene fiber or other articles of polyethylene. Preferably, the polyethylene produced according to the present invention is a polyethylene film.

The polyethylene melt may optionally contain one or more co-additives commonly used in the plastics' industry. Such co-additives may be at least one selected from the group consisting of UV absorbers and light stabilisers; antioxidants; vis-breaking agents; metal deactivators; phosphites and phosphonites; nitrones; thiosynergists; peroxide scavengers; basic co-stabilisers; nucleating agents; fillers and reinforcing agents; other additives; and benzofuranones and indolinones. Other examples of co-additives include slip additives, acid scavengers, for instance as described in Chapter 4 of the Plastic Additives Handbook; lubricants, for instance as described in Chapter 5 of the Plastic Additives Handbook polymer processing aids, for instance as described in Chapter 6 of the Plastic Additives Handbook; anti blocking additives, for instance as given in Chapter 7 of the Plastic Additives Handbook; and antifogging additives, for instance as given in Chapter 9 of the Plastic Additives Handbook. Each refers to Plastic Additives Handbook, 5th Edition, Edited by Hans Zweifel, Hanser Munich, ISBN 3-446-21654-5.

Specific examples of these co-additives are shown below.
1. Antioxidants
   1.1. Alkylated monophenols, for example 2,6-di-tert-butyl-4-methylphenol, 2-tert-butyl-4,6-di methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethyl phenol, 2,6-dioctadecyl-4-methylphenol, 2,4,6-tricyclohexylphenol, 2,6-di-tert-butyl-4-meth oxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′ methylheptadec-1′-yl)phenol, 2,4-dimethyl-6-(1′-methyltridec-1′-yl)phenol and mixtures thereof.
   1.2. Alkylthiomethylphenols, for example 2,4-dioctylthiomethyl-6-tert-butylphenol, 2,4-dioctyl thiomethyl-6-methylphenol, 2,4-dioctylthiomethyl-6-ethylphenol, 2,6-di-dodecylthiomethyl-4-nonylphenol.
   1.3. Hydroquinones and alkylated hydroquinones, for example 2,6-di-tert-butyl-4-methoxy phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
   1.4. Tocopherols, for example a-tocopherol, -tocopherol, y-tocopherol, o-tocopherol and mixtures thereof (vitamin E).
   1.5. Hydroxylated thiodiphenyl ethers, for example 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
   1.6. Alkylidenebisphenols, for example 2,2′-methylenebis(6-tert-butyl-4-methylphenol), 2,2′methylenebis(6-tert-butyl-4-ethylphenol), 2,2′-methylenebis[4-methyl-6-(α-methylcyclohexyl) phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl phenol), 2,2′-ethylidenebis(6-tert-butyl-4-isobutylphenol), 2,2′-methylenebis[6-(a-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert butyl-4-hydroxy-2-methylphenyl) butane, 2,6-bis(3-tert-butyl-5-methyl-2-hydroxybenzyl)-4-methylphenol, 1,1,3-tris(5-tert-butyl-4-hydroxy-2-methylphenyl) butane, 1,1-bis(5-tert-butyl-4-hydroxy-2-methyl-phenyl)-3-n-dodecylmercaptobutane, ethylene glycol bis[3,3-bis(3′-tert butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl) pentane.
   1.7. 0-, N- and S-benzyl compounds, for example 3,5,3′,5′-tetra-tert-butyl-4,4′-dihydroxydi benzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl) sulfide, isooctyl-3,5-di-tert-butyl-4-hydroxybenzylmercaptoacetate.
   1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
   1.9. Aromatic hydroxybenzyl compounds, for example 1,3,5-tris(3,5-di-tert-butyl-4-hydroxy benzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl) phenol.
   1.10. Triazine compounds, for example 2,4-bis(octylmercapto)-6-(3,5-di-tert-butyl-4-hydroxy anilino)-1,3,5-triazine, 2-octylmercapto-4,6-bis(3,5-di-tert-butyl-4-hydroxyanilino)-1,3,5-tri azine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-15 (3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.
   1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hy-droxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
   1.12. Acylaminophenols, for example 4-hydroxylauranilide, 4-hydroxystearanilide, octyl N-(3,5-di-tert-butyl-4-hydroxyphenyl)carbamate.
   1.13. Esters of 13-(3,5-di-tert-butyl-4-hydroxyphenyl) propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol propane, 4-hydroxymethyl-1-phospha-2,6,7-trioxabicyclo[2.2.2]octane.
   1.14. Esters of 13-(5-tert-butyl-4-hydroxy-3-methylphenyl) propionic acid with mono- or poly hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl) oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert butyl-4-hydroxy-5-methylphenyl)propionyloxy}-1,1-dimethylethyl]-2,4,8,10-tetraoxaspiro[5.5]undecane.
   1.15. Esters of 13-(3,5-dicyclohexyl-4-hydroxyphenyl) propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, tri ethylene glycol, pentaerythritol, tris(hydroxyethyl)isocyanurate, N,N′-bis(hydroxyethyl)ox amide, 3-thiaundecanol, 3-thiapentadecanol, trimethylhexanediol, trimethylolpropane, 4-hydroxymethyl-1-phospha-2,6,7-trioxabicyclo[2.2.2]octane.
   1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox amide, 3-thiaundecanol, 3-thiapentadecanol, trimethylhexanediol, trimethylolpropane, 4-hydroxymethyl-1-phospha-2,6,7-trioxabicyclo[2.2.2]octane.
   1.17. Amides of 13-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Nau gard®XL-1, supplied by Uniroyal).
   1.18. Ascorbic acid (vitamin C)
   1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′ phenyl-p-phenylenediamine, 4-(p-toluenesulfamoyl)diphenylamine, N,N′-dimethyl-N, N′-di-5 sec-butyl-p-phenylenediamine, diphenylamine, N-allyldiphenylamine, 4-isopropoxydiphenyl amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetra methyl-4,4′-diaminodiphenylmethane, 1,2-bis[(2-methylphenyl)amino]ethane, 1,2-bis(phenyl amino)propane, (o-tolyl)biguanide, bis[4-(1′,3′-dimethylbutyl)phenyl]amine, tert-octylated N phenyl-1-naphthylamine, a mixture of mono- and dialkylated tert-butyl/tert-octyldiphenyl amines, a mixture of mono- and dialkylated nonyldiphenylamines, a mixture of mono- and dialkylated dodecyldiphenylamines, a mixture of mono- and dialkylated isopropyl/isohexyl diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.
2. UV Absorbers and Light Stabilizers
   2.1. 2-(2′-Hydroxyphenyl)benzotriazoles, for example 2-(2′-hydroxy-5′-methylphenyl)-benzo triazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di tert-butyl-2′-hydroxyphenyl)-5-chlorobenzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′ hydroxy-4′-octyloxyphenyl)benzotriazole, 2-(3′,5′-di-tert-amyl-2′-hydroxyphenyl)benzotriazole, 2-(3′,5′-bis-(a,a-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyl oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl ethyl)phenyl)benzotriazole, 2-(3′-tert-butyl-5′-[2-(2-ethylhexyloxy) arbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; −[—R—CH₂CH₂COO—CH₂CH₂—]₂—, where R=3′-tert-butyl-4′-hydroxy-5′-2H-benzotriazol-2-ylphenyl, 2-[2′-hydroxy-3′-(a,a-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]ben zotriazole.
   2.2. 2-Hydroxybenzophenones, for example the 4-hydroxy, 4-methoxy, 4-octyloxy, 4-decyl oxy, 4-dodecyloxy, 4-benzyloxy, 4,2′,4′-trihydroxy and 2′-hydroxy-4,4′-dimethoxy derivatives.
   2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
   2.4. Acrylates/Cinnamates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β,β-methyl-p-methoxycinnamate, methyl α-carbomethoxy-p-methoxycin-namate, N-(β-carbomethoxy-β-cyanovinyl)-2-methylindoline, neopentyl tetra(α-cyano-β,β-diphenylacrylate. Other cyanoacrylates may also be used and such compounds are given in EP 3587425.
   2.5. Nickel compounds, for example nickel complexes of 2,2′-thio-bis[4-(1,1,3,3-tetramethyl butyl)phenol], such as the 1:1 or 1:2 complex, with or without additional ligands such as n butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or with out additional ligands.
   2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl) hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexa methylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-a-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor 3058 (Clariant; CAS Reg. No. 106917-31-1] 1-(1-acetyl-2,2,6,6-tetramethylpiperidin-4-yl)-3-dodecylpyrrolidine-2,5-dione, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine.
   2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl) oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
   2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl phenyl)-1,3,5-triazine, 2-(2-hydroxy-4-hexyloxy)phenyl-4,6-diphenyl-1,3,5-triazine, 2-(2-hydr oxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecylpentaerythritol diphosphite, bis(2,4-di-tert-butylphenyl)pentaerythritol diphosphite, bis(2,4-di cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl) pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-te tra-tert-butyl-1,1′-biphenyl-2,2′-diyl)phosphite, 5-butyl-5-ethyl-2-(2,4,6-tri-tert-butylphenoxy)-1,3,2-dioxaphosphirane, poly(4,4″{-isopropylidenediphenol}-octylphosphite), poly(4,4′-{isopropylidenebis[2,6-dibromophenol]}-octylphosphite), poly(4,4′-{2,2′-dimethyl-5,5′-di-t-butylphenylsulfide}-pentaerythrityl diphosphite), phosphorous acid, mixed 2,4-bis(1,1-dimethylpropyl)phenyl and 4-(1,1-dimethylpropyl)phenyl triesters (CAS No. 939402-02-5), phosphorous acid, triphenyl ester, polymer with alpha-hydro-omega-hydroxypoly[oxy(methyl-1,2-ethanediyl)], C10-16alkyl esters (CAS No. 1227937-46-3).

The following phosphites are especially preferred:

Tris(2,4-di-tert-butylphenyl) phosphite (Irgafos®168, BASF SE), tris(nonylphenyl) phosphite,

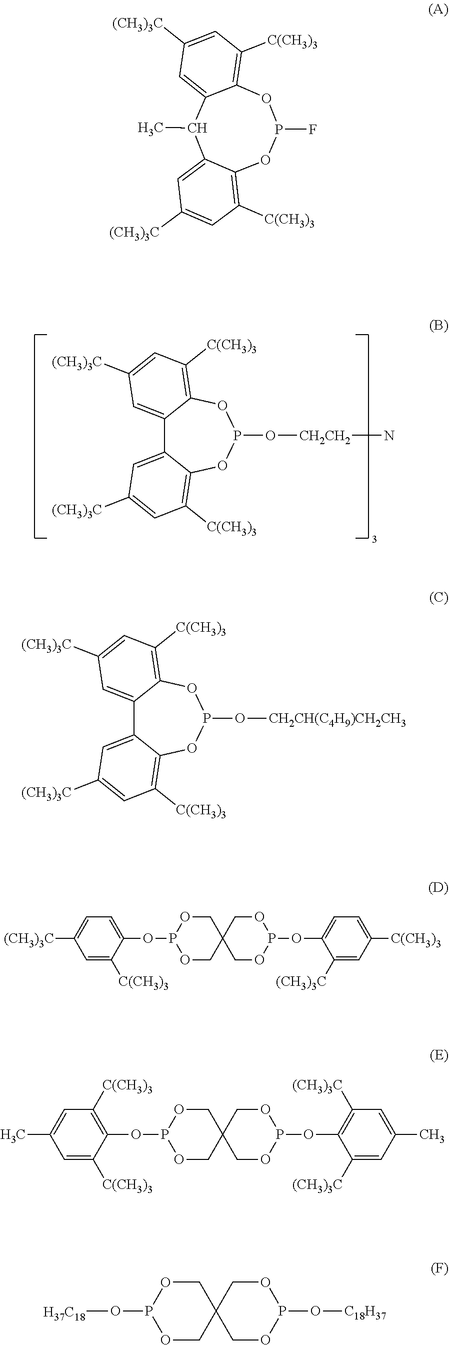

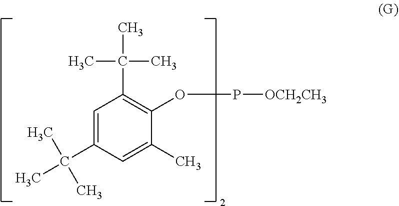

5. Hydroxylamines, for example N,N-dibenzylhydroxylamine, N,N-diethylhydroxylamine, N, N-dioctylhydroxylamine, N, N-dilaurylhydroxylamine, N,N-ditetradecylhydroxylamine, N,N dihexadecylhydroxylamine, N,N-dioctadecylhydroxylamine, N-hexadecyl-N-octadecylhydrox ylamine, N-heptadecyl-N-octadecylhydroxylamine, N, N-dialkylhydroxylamine derived from hydrogenated tallow amine or derived from vegetable source.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecyInnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-hepta decylnitrone, N-octadecyl-alpha-hexadecylnitrone, nitrone derived from N, N-dialkylhydroxyl amine derived from hydrogenated tallow amine.
7. Thiosynergists, for example dilauryl thiodipropionate, dimistryl thiodipropionate, distearyl thiodipropionate, pentaerythritol tetrakis[3-(dodecylthio)propionate] or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercapto benzimidazole, zinc dibutyldithiocarbamate, dioctadecyl disulfide, pentaerythritol tetrakis(β-dodecylmercapto) propionate.
9. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
10. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers).
11. Fillers and reinforcing agents, for example calcium carbonate, silicates, glass fibers, glass beads, asbestos, talc, kaolin, mica, barium sulfate, metal oxides and hydroxides, car bon black, graphite, wood flour and flours or fibers of other natural products, synthetic fibers.
12. Other additives, for example plasticisers, lubricants, emulsifiers, pigments, rheology additives, catalysts, flow-control agents, optical brighteners, flameproofing agents, antistatic agents and blowing agents. Other additives may also include anti-block additives, as referred to above, which are used in films to reduce the negative adhesion of two polyethylene surfaces to one another which would otherwise result in difficulties separating the films. Further additives include slip additives, as referred to above, which are used to help the film surfaces slide over each other. Antifogging agents, as referred to above, may also be added.
13. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di methylphenyl)-5,7-di-tert-butylbenzofuran-2-one, 3-(3,5-dimethyl-4-pivaloyloxyphenyl)-5,7-di tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl benzofuran-2-one. Suitable benzofuranones also include compounds identified in WO2015/121445 and WO2017/025431.
14. Vis-breaking agents
   Vis-breaking agents or generally radical initiators. Typically, this includes organic or inorganic peroxides, which are widely used in industry, bis azo compounds,
   14.1 Peroxides
   Examples of suitable peroxides as vis-breaking agents include 2,5-dimethyl-2,5-di(t-butylperoxy)hexane, 2,5-dimethyl-2,5-di(t-butylperoxy)hexyne-3,3,6,6,9,9-pentamethyl-3-(ethyl acetate)-1,2,4,5-tetraoxy cyclononane, t-butyl hydroperoxide, hydrogen peroxide, dicumyl peroxide, t-butyl peroxy isopropyl carbonate, di-t-butyl peroxide, p-chlorobenzoyl peroxide, dibenzoyldiperoxide, t-butyl cumyl peroxide; t-butyl hydroxyethyl peroxide, di-t-amyl peroxide and 2,5-dimethylhexene-2,5-diperisononanoate, acetylcyclohexanesulphonyl peroxide, diisopropyl peroxydicarbonate, tert-amyl perneodecanoate, tert-butyl-perneodecanoate, tert-butylperpivalate, tert-amylperpivalate, bis(2,4-dichlorobenzoyl) peroxide, diisononanoyl peroxide, didecanoyl peroxide, dioctanoyl peroxide, dilauroyl peroxide, bis(2-methylbenzoyl) peroxide, disuccinoyl peroxide, diacetyl peroxide, dibenzoyl peroxide, tert-butyl per-2-ethylhexanoate, bis(4-chlorobenzoyl) peroxide, tert-butyl perisobutyrate, tert-butyl permaleate, 1,1-bis(tert-butylperoxy)-3,5,5-trimethylcyclohexane, 1,1-bis(tert-butylperoxy)cyclohexane, tert-butyl peroxyisopropyl carbonate, tert-butyl perisononaoate, 2,5-di-methylhexane 2,5-dibenzoate, tert-butyl peracetate, tert-amyl perbenzoate, tert-butyl per-benzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl)benzene, 3,5-bis(tert-butylperoxy)-3,5-di-methyl-1,2-dioxolane, di-tert-butyl peroxide, 2,5-dimethylhexyne 2,5-di-tert-butyl peroxide, 3,3,6,6,9,9-hexamethyl-1,2,4,5-tetraoxacyclononane, p-menthane hydroperoxide, pinane hydroperoxide, diisopropylbenzene mono-α-hydroperoxide, cumene hydroperoxide or tert-butyl hydroperoxide.
14.2. Bis azo compounds
   Such azo compounds are for example 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1, 1 ‘-azobis(1-cyclohexanecarbonitrile), 2,2’-azobis(isobutyramide)dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methylpropane), 2,2′-azobis(N,N′-dimethyleneisobutyramidine) as free base or hydrochloride, 2,2′azobis(2-amidinopropane) as free base or hydrochloride, 2,2′-azobis{2-methyl-N-[1,1-bis(hydroxymethyl)ethyl]propionamide} or 2,2′-azobis{2-methyl-N-[1,1-bis(hydroxymethyl)-2-hydroxyethyl]propionamide.

The co-additive is for example present in the polymer melt in an amount of 0.001 to 10% by weight, preferably 0.001 to 5% by weight, relative to the weight of the polyethylene. Conventional fillers or reinforcing agents may be present in the polymer melt in amounts of 0.1 to 10% by weight, preferably 1 to 5% by weight, in certain cases in amounts up to 70% by weight, relative to the weight of the polyethylene.

The following examples illustrate the present invention. All parts and percentages given by weight unless indicated otherwise.

### EXAMPLES

### Additives Used:

TABLE 1

| | | | Product C | Product D |
|---|---|---|---|---|
| | | | Inventive | Inventive |
| | Product A | Product B | Trisamide | Sorbitol Acetal |
| Additive | Comparative | Comparative | Formula (XIX) | Formula IX |
| CAS No. | 87189-25-1 | 491589-22-1 | 745070-61-5 | 882073-43-0 |
| IUPAC | Zinc,(1,2,3- | calcium | Propanamide, | 1-[8-propyl-2,6- |
| Name | propanetriolato(2)- | (1R,2S)- | N,N′,N′′-1,3,5- | bis(4-propylphenyl)- |
| | kO1,kO2)-, | cyclohexane- | benzenetriyltris[2,2- | 4,4a,8,8a-tetrahydro- |
| | homopolymer, | 1,2-dicarboxylate | dimethyl- | [1,3]dioxino[5,4- |
| | stereoisomer | | | d][1,3]dioxin-4-yl]ethane- |
| | | | | 1,2-diol |

Polypropylene Moplen HP 561R from LYB, ground (PP 2)

### Example 1

### Preparation:

Mixtures were produced using the additives as indicated above in LLDPE (Exxonmobil LL 1002YB Cast, ground) as basis in a highspeed mixer F35 MTU from the company MTI in Germany. The mixtures were compounded at 230 °C. with a double screw compounding unit 25/42D from Collin in Germany to get well homogenized granules.

### Testing of Drawability and Melt Strength:

Drawability and melt strength of the compounds were tested with a rheotense test device connected with a single screw extruder from Gottfert in Germany. The test temperature was 230 °C. The sample was drawn uniaxially to a set of accelerating nips located 100 mm below the die, with an acceleration of 2.4 mm/s2.

The tensile force (cN) was recorded as a function of the take-up speed of the nip rolls. The higher the value the better improvement in terms of melt strength.

Drawability was reported as the maximum ratio of drawing versus initial extrusion rate v/v₀ before appearance of draw resonance as an indication for draw turbulences and limit for increased throughput. Melt strength is the plateau force before the strand breaks. The higher the ratio v/v₀ (draw speed/initial extrusion speed at time zero) the better.

### Results:

TABLE 2

| | | Drawability | Tensile |
|---|---|---|---|
| Test | Formulation | v/vo (—) | force (cN) |
| Comparative 1 | Reference (no | 6.7 | 0.036 |
| | additives) | | |
| Comparative 2 | 0.1% Product A | 7.1 | 0.038 |
| Comparative 3 | 0.2% Product A | 6.8 | 0.046 |
| Comparative 4 | 0.2% Product B | 6.2 | 0.039 |
| Inventive 1 | 0.006% Product C | 6.7 | 0.043 |
| Inventive 2 | 0.012% Product C | 8.3 | 0.048 |
| Inventive 3 | 0.018% Product C | 7.6 | 0.046 |
| Inventive 4 | 0.2% Product D | 7.3 | 0.044 |
| Inventive 5 | 0.4% Product D | 7.8 | 0.046 |

The above results showed that either the drawability and/or the melt strength of the so treated Polyethylenes according to the invention were better than the reference formulation and overall better than the comparative products.

### Example 2

Test of max drawability of LLDPE films on a MDO stretch line:

Mixtures were produced using the additives as indicated above in Example 1 LLDPE (Exxonmobil LL 1002YB Cast, ground) as basis in a highspeed mixer F35 MTU from the company MTI in Germany. The mixtures were compounded at 230 °C with a double screw compounding unit 25/42D from Collin in Germany to get well homogenized granules.

120 micron films were produced on a Colling Cast film line CR 136/230 at 230 °C.

### Testing:

The films were drawn offline on a MDO stretch line, Type MDO-II-350 from Collin in Germany. The films were stretched at 75 °C in two steps with stretch factor 1:2 in first stretch and with continuous increase in stretch factor in step 2. The total stretch achieved before break was noted down.

### Results:

TABLE 3

| | | Max draw factor |
|---|---|---|
| Test | Formulation | on MDO line |
| Comparative 1 | Reference (no additives) | 5 |
| Comparative 2 | 0.1% Product A | 5 |
| Comparative 3 | 0.2% Product B | 5 |
| Inventive 1 | 0.006% Product C | 8.6 |
| Inventive 2 | 0.012% Product C | 8.8 |
| Inventive 3 | 0.018% Product C | 6.8 |
| Inventive 4 | 0.2% Product D | 8.8 |
| Inventive 5 | 0.4% Product D | 6.2 |

The above results showed that the inventive Polyethylene films had better drawability than the reference formulation and the comparative formulations.

1-16. (canceled)

17. A method for increasing melt strength and/or drawability tested with a rheotense test device of a polyethylene by adding an additive to the polyethylene, wherein the additive is at least one compound selected from the group consisting of trisamides, wherein the trisamide is an aromatic trisamide of formula (VII) 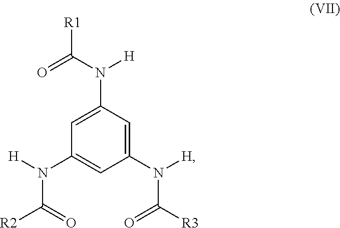
wherein R1, R2 and R3 are each independently selected from the group consisting of C₁-C₅ linear, branched alkyl, substituted and unsubstituted C₃-C₆ cycloalkyl; and wherein the polyethylene comprises the additive in an amount of from 0.005 to 0.1 wt. %.

18. The method of claim 17, wherein the polyethylene has a density of from 0.915 to 0.960 g/cm³.

19. The method of claim 17, wherein the additive is an aromatic trisamide of formula (VII) 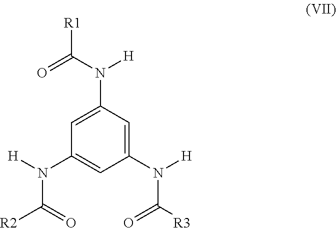
wherein R1, R2 and R3 are all tertiary butyl.

20. The method of claim 17, wherein the polyethylene comprises the additive in an amount of from 0.005 to 0.02 wt. %.

21. The method of claim 17, wherein the polyethylene is a polyethylene film.

22. The method of claim 17, comprising:
adding at least one co-additive selected from the group consisting of a light stabiliser, an antioxidant, a vis-breaking agent, a metal deactivator, a phosphite and phosphonite, a nitrone, a thiosynergist, a peroxide scavenger, a basic co-stabiliser, a nucleating agent, a filler and reinforcing agent, a benzofuranone, an indolinone, a slip additive, an acid scavenger, an anti blocking additive and an antifogging additive.
